(19) United States
(12) Patent Application Publication
(10) Pub. No.: US 2021/0034220 A1
(43) Pub. Date: Feb. 4, 2021

(54) CONTROL METHOD OF HANDHELD ELECTRONIC DEVICE

(71) Applicant: ASUSTEK COMPUTER INC., Taipei (TW)

(72) Inventors: I-Hsi WU, Taipei (TW); Hsin-Yi PU, Taipei (TW); Wen-Fang HSIAO, Taipei (TW)

(21) Appl. No.: 16/528,364

(22) Filed: Jul. 31, 2019

(51) Int. Cl. G06F 3/041; G06F 3/0488

(52) U.S. Cl. CPC G06F 3/04186; G06F 3/0412; G06F 3/04146; G06F 3/0488

(57) ABSTRACT

A control method of a handheld electronic device with a touch panel is provided. The control method includes the following steps. Firstly, a user interface is displayed by the touch panel, where the user interface includes a sensing area corresponding to a predefined function. Then, an adjusting function for the sensing area is enabled. Afterward, it is determined whether the sensing area receives an adjusting instruction or not, and when the sensing area receives the adjusting instruction, the sensing area is adjusted according to the adjusting instruction and the size change process is continuously presented on the touch panel. The adjusted sensing area still corresponds to the predefined function.

### BACKGROUND OF THE INVENTION

### Field of the Invention

The disclosure relates to a control method, and in particular, to a control method of a handheld electronic device.

### Description of the Related Art

With the development of handheld devices, games for handheld devices are becoming more and more popular. Generally speaking, handheld devices are equipped with a touch screen for the user to perform touch operations.

However, limited by the screen size of the handheld device, the sensing area of the user interface displayed on the screen is also too small, which is unfavorable for the user to operate.

### BRIEF SUMMARY OF THE INVENTION

The disclosure provides a control method applied to a handheld electronic device including a touch panel. The control method includes: displaying a user interface by the touch panel, where the user interface includes a sensing area with a first size and the sensing area corresponds to a predefined function; enabling an adjusting function for the sensing area; determining whether the sensing area receives an adjusting instruction or not, where the adjusting instruction is used to adjust the sensing area from the first size to a second size; and when the sensing area receives the adjusting instruction, a size of the sensing area is adjusted according to the adjusting instruction and the size change process is continuously presented during the adjustment until the sensing area reaches the second size, wherein the adjusted sensing area also corresponds to the predefined function.

According to the control method of a handheld electronic device that disclosed in the disclosure, the range of the predefined sensing area on the user interface is adjusted to improve the hit rate of the user tapping in the sensing area. Therefore, the problem of inaccurately hitting in the sensing area caused by the small size of the handheld electronic device is solved, thereby enhancing user experience.

Specific embodiments of the disclosure will be further described by using the following examples and drawings.

### BRIEF DESCRIPTION OF THE DRAWINGS

FIG. 1 is a schematic block diagram of an embodiment of a handheld electronic device according to the disclosure;

FIG. 2 is a flowchart of an embodiment of a control method of a handheld electronic device according to the disclosure; and

FIG. 3A to FIG. 3E show an embodiment of operation of a handheld electronic device by using a touch panel of the handheld electronic device for display.

### DETAILED DESCRIPTION OF THE EMBODIMENTS

Specific embodiments of the disclosure will be described in further detail below with reference to schematic drawings. The advantages and features of the disclosure will become more apparent from the following description and claims. It should be noted that the drawings are all in a very simplified form and are not drawn to accurate scale, but are merely used for convenience and clarity of description of the embodiments of the disclosure.

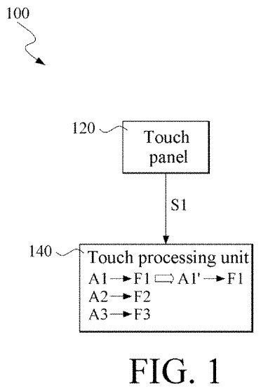

FIG. 1 is a schematic block diagram of an embodiment of a handheld electronic device according to the disclosure. As shown in FIG. 1, the handheld electronic device includes a touch panel 120 and a touch processing unit 140. The touch processing unit 140 is electrically connected to the touch panel 120, and is configured to control operation of the touch panel 120. The handheld electronic device 100 is a mobile phone, a tablet computer, a handheld game console, or any other handheld electronic devices including touch panels. Specific operations of the touch processing unit 140 in this embodiment will be described in further detail in subsequent paragraphs.

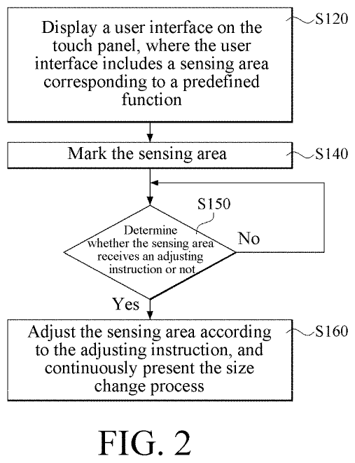

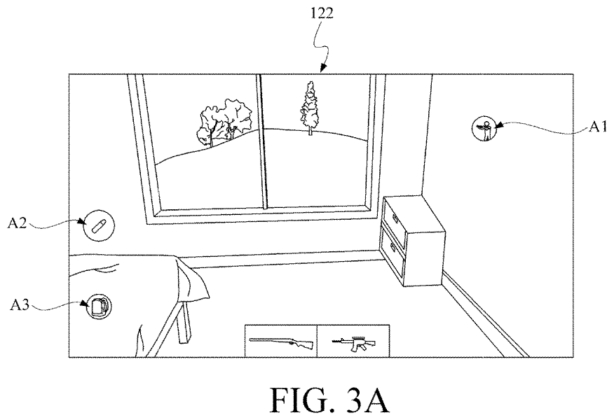

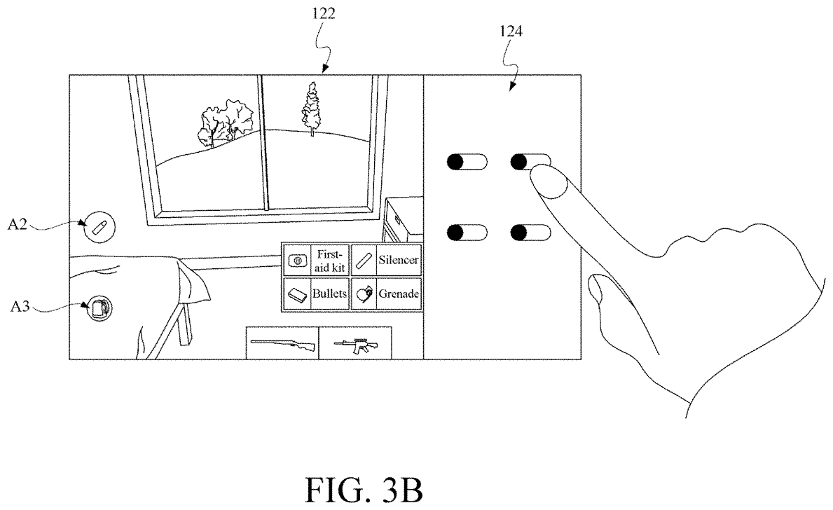

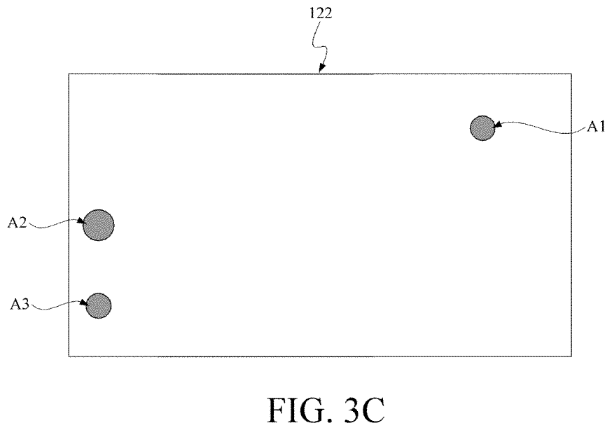

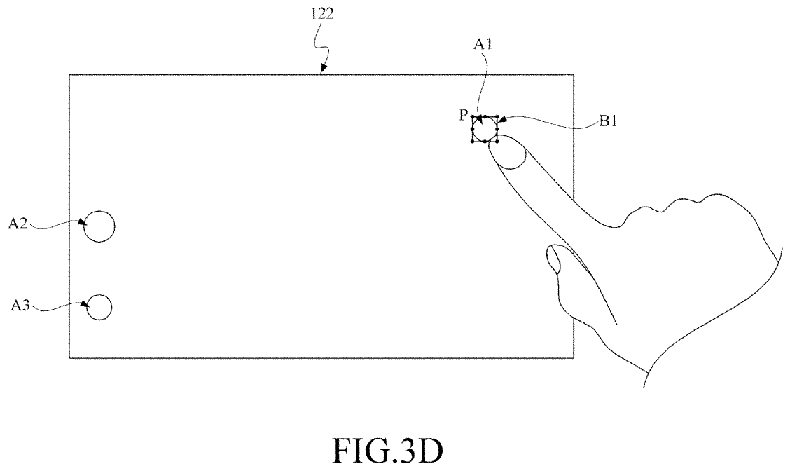

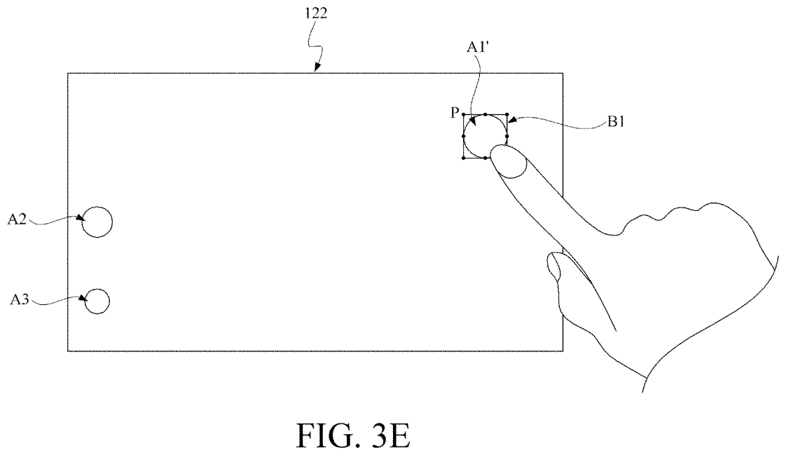

Referring to FIG. 2 and FIG. 3A to FIG. 3E, FIG. 2 is a flowchart of an embodiment of a control method of a handheld electronic device according to the disclosure, and FIG. 3A to FIG. 3E show the control method shown in FIG. 2 by using a user interface 122 displayed on a touch panel. The control method is applied to the handheld electronic device 100 shown in FIG. 1, and is performed by the touch processing unit 140.

First, in step S120, a user interface 122 is displayed by the touch panel 120. The user interface 122 includes a sensing area, and the sensing area corresponds to a predefined function. In an embodiment, at least one sensing area is preset on the user interface shown in FIG. 3A. In an embodiment, three sensing areas A1, A2, and A3 are shown in FIG. 3A. Three sensing areas A1, A2, and A3 correspond to predefined functions F1, F2, and F3 respectively. In an embodiment, the user interface is a computer game interface, and each of the sensing areas A1, A2, and A3 correspond to different operation instructions of a computer game, including moving, crouching, shooting, and the like. In another embodiment, ranges of the sensing areas A1, A2, and A3 are preset, and the predefined functions also include vibration or a sound effect and are used in combination with different operation instructions.

Then, in step S140, an adjusting function for the sensing area is enabled, and positions of the sensing areas A1, A2, and A3 are marked for adjustment by the user. In an embodiment, referring to FIG. 3B, in this step, the adjusting function for the sensing area is enabled through a function control page 124. In addition, referring to FIG. 3C, in an embodiment, after the adjusting function for the sensing area is enabled, the positions of the sensing areas A1, A2, A3 are marked in a color that different from that of the background of the user interface 122. Which helps the user determines the current sensing ranges of the sensing areas A1, A2, and A3 and determines whether the sensing ranges of the sensing areas A1, A2, and A3 needs to be adjusted.

Then, in step S150, it is determined whether the sensing area A1 receives an adjusting instruction S1 or not. The adjusting instruction S1 is used to adjust the size of the sensing area A1 from a first size (an original size) to a second size (which is set by the user). Referring to FIG. 1, FIG. 3D, and FIG. 3E, when the user decides to adjust the sensing range of the sensing area A1, the user inputs the adjusting instruction S1 to the touch panel 120. In an embodiment, the adjusting instruction S1 is a touch instruction. In an embodiment, the user generates the adjusting instruction S1 by sliding and dragging, so as to adjust the sensing range of the sensing area A1.

When the sensing area A1 receives the adjusting instruction S1, in step S160, referring to FIG. 3E, the touch processing unit 140, after receiving the adjusting instruction S1 from the sensing area A1, adjusts the sensing range of the sensing area A1 according to the instructing instruction S1, and displays the corresponding size of the sensing area (that is, displays the process of changing from the sensing area A1 to the sensing area A1′) during the adjustment on the touch panel 120, until the sensing area reaches the second size (that is, is adjusted to the set size).

In addition, the adjusted sensing area A1′ corresponds to the predefined function F1 that corresponding to the original sensing area A1. In this way, in the process of operating through the user interface 122, the predefined function F1 is enabled as long as the user taps on a position within the range of the sensing area A1′ without the need to precisely tap on a position within the sensing area A1.

By means of the control method, the hit rate of the user tapping in the sensing area is improved, so that the problem of inaccurately hitting in the sensing area caused by the small size of the handheld electronic device is solved, thereby enhancing user experience.

Referring to FIG. 3D and FIG. 3E, in an embodiment, the sensing area A1 before the adjustment is in the same shape as the sensing area A1′ after the adjustment. In an embodiment, the sensing area A1 before the adjustment is circular, and the sensing area A1′ after the adjustment is also circular, which is obtained by enlarging the sensing area A1 by a certain scale. According to practical usage requirements, the sensing area A1 before the adjustment and the sensing area A1′ after the adjustment are presented in different shapes in some embodiments. In an embodiment, the sensing area A1 before the adjustment is circular, and the sensing area A1′ after the adjustment is lengthened in the longitudinal direction to present an elliptical shape.

Then, referring to FIG. 3D and FIG. 3E, in an embodiment, the sensing area A1 is circular, adjustment is performed according to the shape of the sensing area A1 in step S160. In some embodiments, according to practical requirements of user interface design, the sensing area is in square, triangle, or irregular shapes.

In addition, referring to FIG. 3D and FIG. 3E, when the user adjusts the sensing range of the sensing area A1 through sliding and dragging, a box B1 is displayed around the sensing area A1. The box B1 surrounds the sensing area A1, and includes a plurality of feature points P (only one of the feature points is marked in the figures) to define a plurality of adjustment directions. Once the user touches and moves the feature points P, the adjusting instruction S1 is generated.

The manner in which the touch processing unit 140 adjusts the sensing area A1 varies with different adjusting instructions S1.

In an embodiment, the adjusting instruction S1 includes an X-axis adjusting instruction and a Y-axis adjusting instruction. The touch processing unit 140 adjusts the width and position of the sensing area A1 in an X-axis direction according to the X-axis adjusting instruction, and adjusts the width and position of the sensing area A1 in a Y-axis direction according to the Y-axis adjusting instruction, so as to define the sensing area A1′ after the adjustment.

In an embodiment, the adjusting instruction S1 includes an enlargement scale signal and a position signal. The touch processing unit 140 adjusts the size of the sensing area A1 according to the enlargement scale signal, and adjusts the position of the sensing area A1 according to the position signal, so as to define the sensing area A1′ after the adjustment.

Generally, the position of the sensing area A1 corresponds to a particular icon on the user interface 122. To prevent the sensing area A1′ after the adjustment from deviating from the icon, in an embodiment, the adjusting instruction S1 is defined as an enlargement scale signal. The touch processing unit 140 adjusts the size of the sensing area A1 according to the enlargement scale signal to, so as to define the sensing area A1′ after the adjustment without changing the position of the sensing area A1. In addition, in an embodiment, the touch processing unit 140 sets an adjustment range of the adjusting instruction S1 according to the size of the original sensing area A1. In an embodiment, the touch processing unit 140 sets the sensing area A1′ after the adjustment to encompass the original sensing area A1; or sets the size of the sensing area A1′ after the adjustment be larger than that of the original sensing area A1.

By means of the control method of a handheld electronic device according to the disclosure, the range of the predefined sensing area on the user interface is adjusted to improve the hit rate of the user tapping in the sensing area. Therefore, the problem of inaccurately hitting in the sensing area caused by the small size of the handheld electronic device is solved, thereby enhancing user experience.

The foregoing descriptions are merely preferred embodiments of the disclosure and are not intended to limit the disclosure in any way. Any person skilled in the art can make any form of equivalent replacement or modification to the technical means and technical contents disclosed by the disclosure without departing from the scope of the technical means of the disclosure, and such equivalent replacement or modification does not depart from the contents of the technical means of the present disclosure and still falls within the protection scope of the disclosure.

1. A control method of a handheld electronic device with a touch panel, the control method comprising:
displaying a user interface by the touch panel, wherein the user interface comprises a sensing area with a first size and the sensing area corresponds to a predefined function;
enabling an adjusting function for the sensing area;
determining whether the sensing area receives an adjusting instruction or not, wherein the adjusting instruction is used to adjust the sensing area from the first size to a second size; and
when the sensing area receives the adjusting instruction, a size of the sensing area is adjusted according to the adjusting instruction and a size change process of the sensing area is continuously presented during the adjustment, until the sensing area reaches the second size,
wherein the adjusted sensing area still corresponds to the predefined function, and
wherein the size of the sensing area is adjusted by touching and moving at least one feature point.

2. The control method according to claim 1, wherein the adjusting instruction comprises an X-axis adjusting instruction and a Y-axis adjusting instruction, and widths and positions of the sensing area in an X-axis direction and a Y-axis direction are adjusted according to the X-axis adjusting instruction and the Y-axis adjusting instruction.

3. The control method according to claim 1, wherein the adjusting instruction is a touch instruction.

4. The control method according to claim 1, wherein the adjusted sensing area is round or elliptical.

5. The control method according to claim 1, wherein the adjusting instruction comprises an enlargement scale signal, and the size of the sensing area is adjusted according to the enlargement scale signal.

6. The control method according to claim 1, wherein the adjusting instruction comprises an enlargement scale signal and a position signal, the size of the sensing area is adjusted according to the enlargement scale signal, and a position of the sensing area is adjusted according to the position signal.

7. The control method according to claim 1, wherein a position of the sensing area remains unchanged.

8. The control method according to claim 1, wherein the adjusted sensing area encompasses the sensing area before the adjustment.
